(19) United States
(12) Patent Application Publication
(10) Pub. No.: US 2002/0147971 A1
(43) Pub. Date: Oct. 10, 2002

(54) Object-oriented class loading system and method

(76) Inventor: James Andrew Adams, Apex, NC (US)

Correspondence Address: Jones, Day, Reavis & Pogue, North Point, 901 Lakeside Avenue, Cleveland, OH, 44114, US

(21) Appl. No.: 09/784,505

(22) Filed: Feb. 15, 2001

(51) Int. Cl. G06F 9/44

(52) U.S. Cl. 717/165; 717/166

(57) ABSTRACT

A computer-implemented method and system for loading an object class into computer memory for access by an object-oriented application. A first object class is loaded into the computer memory, and initially a classload request for the first object class traverses from a first classloader to a second classloader. A destructible classloader is created that contains a second object class which may be a modification of the first object class. After creating the destructible classloader, the classload request traverses from the first classloader to the destructible classloader and then to the second classloader. The destructible classloader attempts to load into the computer memory the second object class if the second classloader fails to load the second object class.

### BACKGROUND

1. Technical Field

The present invention is generally directed to object-oriented programming languages, and more specifically to the field of object-oriented class handling.

2. Description of Related Art

Certain object-oriented languages use a garbage collection scheme to manage all objects loaded into the environment. When there are no more uses of an object, it is removed from the system. Objects are per instance repositories of data and state. The functionality of the object is defined by its class. Classes are objects also, and thus, stay in memory until there are no more references to them. For example in the Java environment, a classloader object loads classes and maintains a reference to the class. This ensures that class loading is not an intensive operation because if a class is already loaded, then the classloader does not need to reload it. In addition classes are defined as the tuple of the classloader that loaded them and the code that implements them. Two classes with the same name, loaded by two different class loaders, are never thought of as the same class.

Current class loading approaches experience significant difficulties when classes are to be unloaded and reloaded into computer memory. One such case is while using a development environment to develop classes. It is desirable to modify a class and then unload the old class and reload the new class. Another case is in an operation that must be running substantially continuously (e.g., twenty-four hours a day and seven days a week). Currently, any changes that are required in a class require that operations be suspended and restarted. These disadvantages and others render the current approaches to class loading and reloading undesirable.

### SUMMARY

The present invention solves the aforementioned disadvantages as well as other disadvantages. In accordance with the teachings of the present invention, a computer-implemented method and system are provided for loading an object class into computer memory for access by an object-oriented application. A first object class is loaded into the computer memory, and initially a classload request for the first object class traverses from a first classloader to a second classloader. A destructible classloader is created that contains a second object class which may be a modification of the first object class. After creating the destructible classloader, the classload request traverses from the first classloader to the destructible classloader and then to the second classloader. The destructible classloader attempts to load into the computer memory the second object class if the second classloader fails to load the second object class.

### BRIEF DESCRIPTION OF THE DRAWINGS

FIG. 1 is a system block diagram depicting software components of the present invention for loading and unloading classes in accordance with the teachings of the present invention;

FIG. 2 depicts exemplary source code for swapping classloaders in accordance with the teachings of the present invention;

FIG. 3 is a system block diagram depicting software components of the present invention for loading and unloading classes for use by a software application;

FIG. 4 is a class loading structure diagram depicting parent-child relationships between classloaders used within the present invention;

FIGS. 5-7 are flow charts depicting the steps to load into memory a new class for use within a software development environment; and

FIG. 8 is a flow chart depicting the steps to load into memory a new class for use by an application that is substantially continuously in operation.

### DETAILED DESCRIPTION OF THE PREFERRED EMBODIMENT

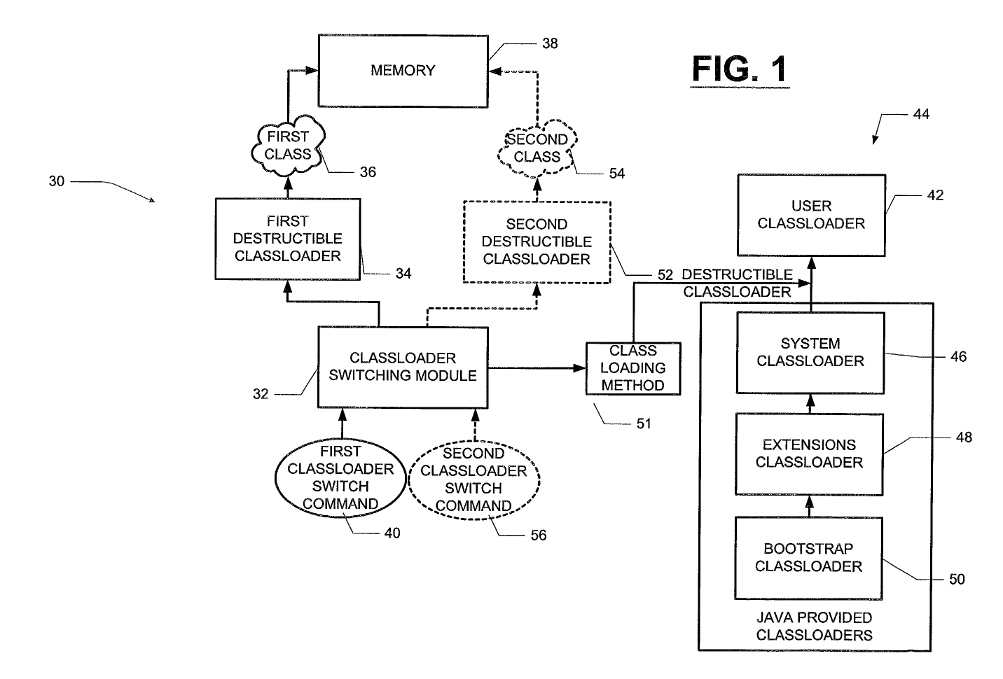

FIG. 1 shows a class processing system 30 that allows classes to be loaded and unloaded from memory such that the loading process is transparent to an application that is using the classes. Classes may be loaded and unloaded via system 30 so that entirely new classes or modifications to already loaded classes may be used by the application without requiring the application to be stopped and restarted.

System 30 includes a classloader switching module 32 that generates a first destructible classloader 34 that loads a first class 36 into memory 38. The classloader switching module 32 loads the first destructible classloader 34 upon receiving a first classloader switch command 40. The first classloader switch command 40 indicates to the classloader switching module 32 that the first class 36 should be loaded into memory 38. Classloader switching module 32 is able to load the first class 36 into memory 38 since it transparently inserts itself within the parent-child hierarchy 44 of the pre-existing classloaders.

As an example of a pre-existing classloader hierarchy, the Java environment from Sun Microsystems, Inc. provides the classloading hierarchy shown at reference numeral 44. Within the Java classloading hierarchy 44, system classloader 46 is a child classloader of the extensions classloader 48 which is a child of the bootstrap classloader 50. Bootstrap classloader 50 does not have a parent as it is the root node in the hierarchy 44.

A user classloader 42 can be installed as a child of the system classloader 46 by the user for holding user-defined classes. However, the user classloader 42 suffers from the disadvantage of necessitating the stopping of an application in order to load new classes for the user classloader 42. Other classloaders may be used as discussed below, such as an applet classloader.

Within the Java environment, classloading uses a delegating parent model, meaning that when a classloader is asked to load a class, it first delegates the opportunity to load the requested class to its parent classloader. Only if the parent has not already loaded the class and cannot load the class, does the child classloader have the opportunity to provide the class requested, if it can. This means that classloaders form a hierarchical tree with the bootstrap classloader 50 as the root of the tree. There are several implication of this classloader scheme. One of the implications is that classes are loaded using the classloader of the calling class. Classes that need to be loaded by a child classloader will not be loaded because there is no parent to child connection. To get around this, the classloading mechanism allows you to specify a classloader to use to load a class:

Class.forName(“com.myCompany.MyClass”, my ClassLoader)

In most situations, the system does not know which classloader to use. Since most situations require the system classloader 46 to be used, the classloader class provides an operation to return the system classloader 46 through the following class loading method which is shown at reference numeral 51:

Classloader.getSystemClassLoader( )

This method 51 is usable in an application, such as when the application is loaded and running on a client machine. The pre-existing Java hierarchy 44 only allows classes to be reloaded if they are loaded with a new classloader and after stopping and restarting the application. In addition, most applications are written to be provided/loaded by the system classloader. Since it is not possible to transparently unload the classes loaded by the system classloader within the pre-existing Java hierarchy 44, the user must stop and restart the application to install class changes.

The present invention addresses this disadvantage as well as other disadvantages of such classloading hierarchical approaches as the Java hierarchy 44. The present invention provides a fourth classloader (e.g., the first destructible classloader 34) that makes the fourth classloader “look like” the system classloader. Since the present invention has control over the new classloader, the new classloader can be released and another new classloader may be added with class changes at anytime (without having to stop and restart the application to install the class changes). References to any classes that the software development environment may hold are released, and recreation is facilitated so that the new classes may be loaded into memory. The releasing and recreation are performed transparently in that the pre-existing classloaders do not know that the new “destructible” classloader has been inserted into the class loading hierarchy. Likewise, the new “destructible” classloader does not need know the entire structure of the pre-existing classloading hierarchy since it (and not the system classloader) is automatically returned via the Classloader.getSystemClassLoader( ) method call 51 and knows that its parent is the system classloader. In this manner, the present invention allows system 30 to be relatively unaware of its environment.

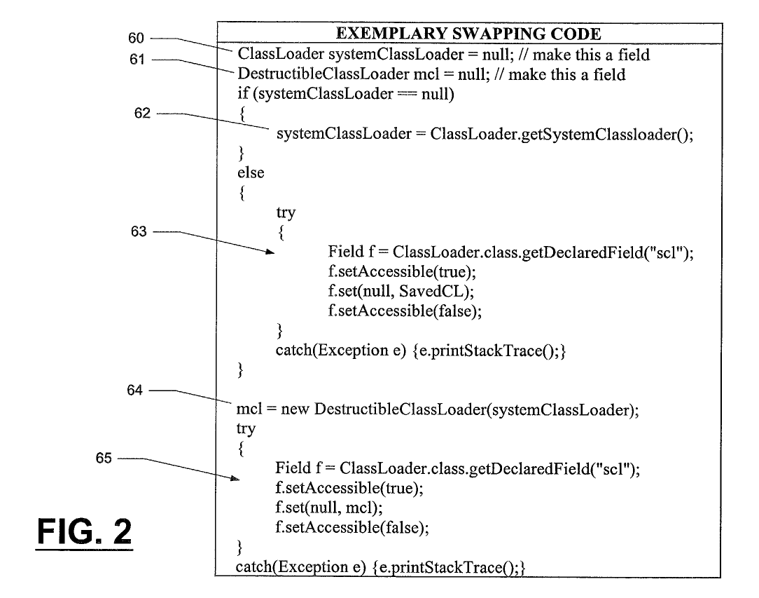

More specifically, the system classloader is held in a private field on the classloader class. The present invention switches out the classloader that is cached and replaces it with a new destructible classloader. The present invention saves the reference to the “old” classloader and replaces it when the present invention is done with the new classloader. This is because that reference is used as the default parent classloader when a new classloader is created. FIG. 2 shows exemplary Java source code that may be used to perform the swapping.

With reference to FIG. 2, source code line 60 shows the saving of the original classloader. At source code line 60, “systemClassLoader” represents the original classloader returned by Classloader.getSystemClassLoader( ). It is saved so that a new destructible classloader may be created. At source code line 61, “DestructibleClassLoader” represents the current destructible classloader. Source code lines 61 and 62 represent fields for holding the classloader instances so that they may exist beyond the scope of the specific method.

The “If” statement 62 examines whether the system classloader has been saved. If the system classloader has not been saved (as when the swapping code is being invoked for the first time by an application), then source code line 62 saves the system classloader. However, if the system classloader has been saved (as in subsequent invocations of the swapping code), then the else block 63 replaces the current destructible classloader with the original system classloader. Source code line 64 constructs a new destructible classloader that has the new class information. Block 65 replaces the system classloader with the new destructible classloader. As is readily apparent to those skilled in the art, the source code depicted in FIG. 2 is an example of one implementation, since the swapping code may assume many implementations depending upon the object-oriented language used and the application at hand.

With reference back to FIG. 1, the classloader switching module 32 creates the first destructible classloader 34 so as to insert the first destructible classloader 34 within the classloader hierarchy. For example, the user classloader 42 has at its parent the system classloader 46. The classloader switching module 32 manipulates the Classloader.getSystemClassLoader( ) method 51 to return the first destructible classloader 34 as the parent of the user classloader 42. The first destructible classloader 34 has, as its parent, the system classloader 46, thereby inserting itself into the overall classloader hierarchy 44.

If the user wishes to load into memory 38 a modification of the first class 36, the user issues a second classloader switch command 56 to the classloader switching module 32. The classloader switching module 32 then removes the first destructible classloader 34 so that a second destructible classloader 52 may be created. Consequently, the classloader switching module 32 inserts the second destructible classloader 52 in the position of the hiearchy 44 that was originally occupied by the first destructible classloader 34 by “spoofing” the class loading method 51 in the manner described above. The second destructible classloader 52 contains the modified class information (i.e., second class 54) and upon invocation loads the modified class information into memory 38 for use by the application.

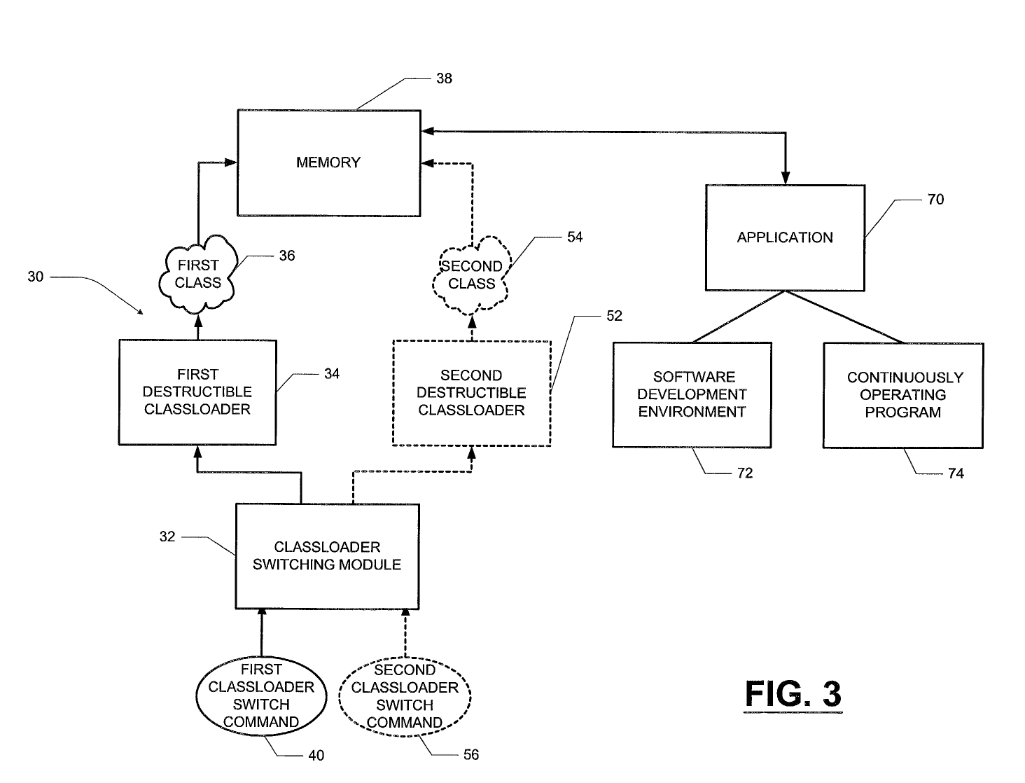

FIG. 3 depicts but a few of the many types of applications 70 that may utilize the present invention. For example, application 70 may be a Java software development environment application 72. Frequently within a Java software development environment, a software developer needs to load and unload classes. This typically happens while a class is under development and needs to be tested or used.

Another exemplary application 70 is an object-oriented computer program 74 that is substantially in continuous operation, such as in a web server environment that is servicing web page requests. Such web server environments typically demand that their operations run twenty-four hours a day, seven days a week. There are situations when classes must be unloaded and reloaded with tearing down the entire web server service. Accordingly, the ability by the present invention to transparently and iteratively load and unload new class information provides significant benefits for this type of application as well as for other applications where classes need to be unloaded and reloaded.

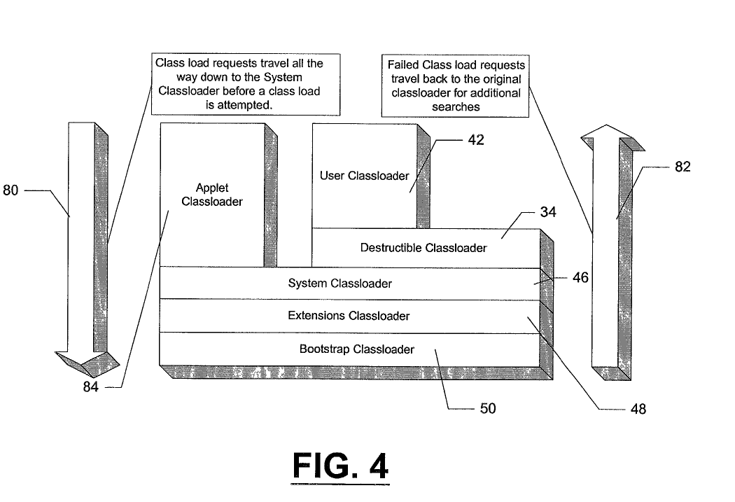

FIG. 4 depicts the structure of the present invention in processing classload requests. Arrow 80 indicates that classload requests travel from a requesting classloader down to the bootstrap classloader 50 before a classload is attempted. Arrow 82 indicates that failed classload requests travel back to the original classloader for additional searches. For example, if an object within the extensions classloader 48 makes a classload request, the object typically asks the extensions classloader 48 to process the load request. The extensions classloader 48 asks the bootstrap classloader 50 first to load the class. If the bootstrap classloader 50 is unsuccessful, then the extensions classloader 48 will attempt to load the class. If that fails, the classload is rejected. Instead, the object can ask the system classloader 46 to load the class using Classloader.getSystemClassLoader( ).loadClass( ). Instead of the system classloader 46 being returned as the classloader, the destructible classloader 34 is returned due to the swapping performed by the present invention.

Arrow 80 indicates that the destructible classloader 34 calls its parent to process a load request. The parent of the destructible classloader 34 is the system classloader 46. The system classloader 46 in turn calls its parent, the extensions classloader 44, which likewise calls its parent, the bootstrap classloader 50, to process the classload request.

Bootstrap classloader 50 attempts to load the requesting class. However, if the requesting class is not within the set of classes created by the bootstrap classloader 50, the bootstrap classloader 50 cannot load the class, and the bootstrap classloader 50 returns processing to the object that called it which was its child (the extensions classloader 44). If the extensions classloader 44 cannot service the load request, then it similarly passes processing to its child, the system classloader 46. Likewise, if the system classloader 46 cannot process the request, processing continues at its caller which is the destructible classloader 34. The destructible classloader 34 can service the classload request if the requested class is one of the classes specified within the destructible classloader 34. In this way, the destructible classloader 34 of the present invention can be used to transparently insert itself into the hierarchy of the classloader structure in order to supply modified classes to an application.

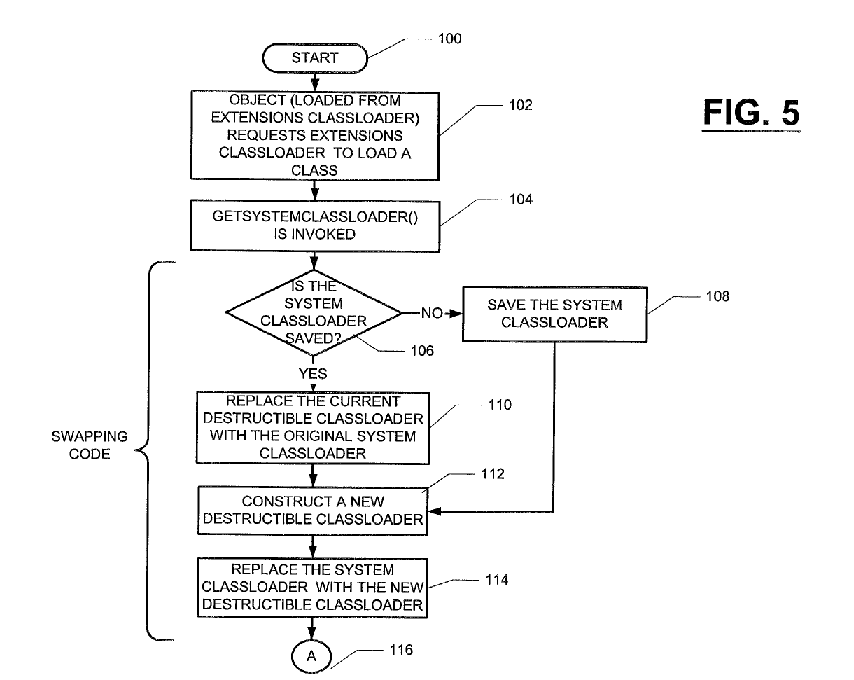

FIGS. 5-7 are flowcharts that depict an exemplary use of the present invention within the context of a software development environment application. The software development environment application is able to handle such events as class editing, class compiling, and class inspection. With reference to FIG. 5, start block 100 indicates that at process block 102 an object issues a request to load a class. In this example, the object was originally loaded from the extensions classloader. Accordingly, the object requests the extensions classloader to load the class.

At process block 104, the extensions classloader invokes the object loading mechanism which calls the Classloader.getSystemClassLoader( ) method. In processing the Classloader.getSystemClassLoader( ) method, decision block 106 examines whether the system classloader has been saved. If the system classloader has not been saved (as when the present invention is being invoked for the first time by an application), process block 108 saves the system classloader, and process block 112 constructs a new destructible classloader.

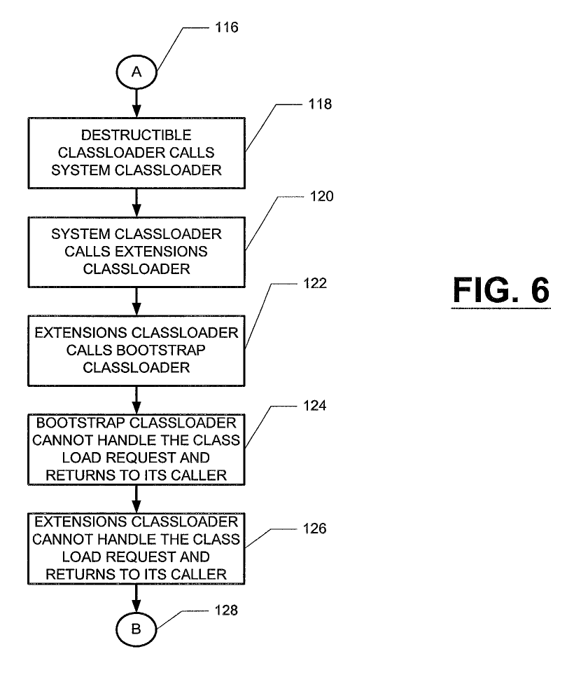

However, if the system classloader has been saved (as in subsequent invocations of the present invention), process block 110 replaces the current destructible classloader with the original system classloader. Process block 112 constructs a new destructible classloader with the new class information. Process block 114 replaces the system classloader with the new destructible classloader. Processing continues on FIG. 6 as shown by continuation indicator 116.

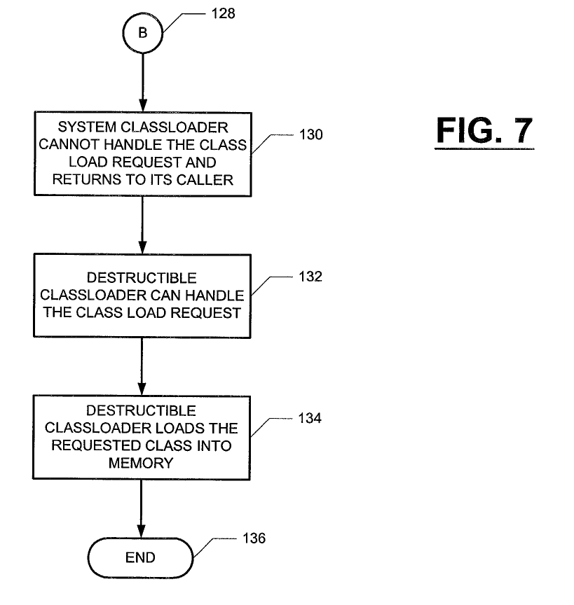

With reference to FIG. 6, the destructible classloader calls its parent the system classloader in order to service the load class request at process block 118. At process block 120, the system classloader calls its parent, the extensions classloader, and the extensions classloader calls its parent, the bootstrap classloader, at process block 122. The bootstrap classloader in this example cannot handle the classload request because the requested class is one of the new classes specified within the destructible classloader. Consequently, the bootstrap classloader returns processing to its caller at process block 124. At process block 126, the extensions classloader cannot handle the classload request and returns to its caller which is the system classloader. Processing continues on FIG. 7 as shown by continuation indicator 128.

With reference to FIG. 7, the system classloader cannot handle the classload request and at process block 130 the system classloader returns to its caller which is the destructible classloader. At process block 132, the destructible classloader can service the classload request since the requested class is contained within the set of classes of the destructible classloader. The destructible classloader loads the requested class into memory for use by the application at process block 134. Processing for this example terminates at block 136.

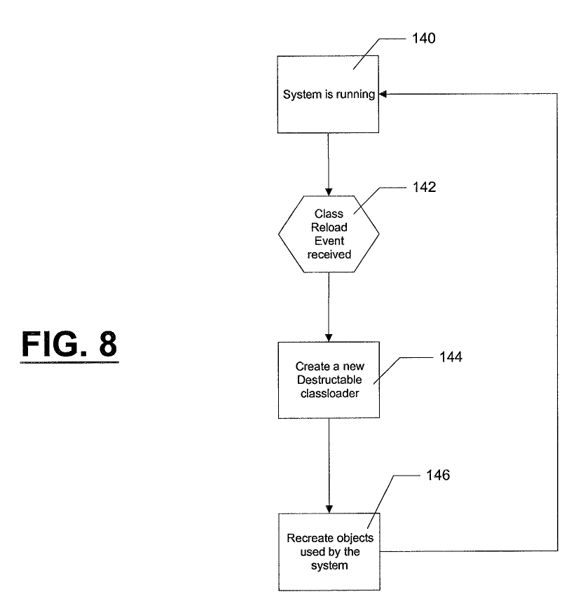

FIG. 8 depicts an exemplary use of the present invention within the context of a substantially continuously operating application, such as in a web server environment. Process block 140 indicates that the system is running when a class reload event is received from a user as indicated by event indicator 142. The class reload event indicates that a new class needs to be added and accessible to the running system. The new class in this example is a class that has been modified to correct an error in one of its classes. At process block 144, a new destructible classloader is created according to the teachings of the present invention such that the new class is loaded and accessible to the running system without stopping the running system. Process block 146 recreates the objects used by the system while the system is still operating. In this way, the creation and use of the new destructible classloader to service classload requests do not necessitate the stopping of the running system.

The preferred embodiments described herein are presented only to demonstrate an example of the invention. Additional and/or alternative embodiments of the invention would be apparent to one of ordinary skill in the art upon reading this disclosure.

It is claimed:

1. A computer-implemented method for loading an object class into computer memory for access by an object-oriented application, comprising the steps of:
loading into the computer memory a first object class, wherein a classload request for the first object class traverses from a first classloader to a second classloader;
creating a destructible classloader that contains a second object class,
wherein after creating the destructible classloader, the classload request traverses from the first classloader to the destructible classloader and then to the second classloader; and
wherein the destructible classloader attempts to load into the computer memory the second object class if the second classloader fails to load the second object class.

2. The method of claim 1 wherein the second object class of the destructible classloader contains a variation of the classes specified in the first object class.

3. The method of claim 1 further comprising the steps of:
unloading the destructible classloader;
creating a second destructible classloader that contains a third object class,
wherein after creating the second destructible classloader, a classload request for the third object class traverses from the first classloader to the second destructible classloader and then to the second classloader; and
wherein the second destructible classloader attempts to load into the computer memory the third object class if the second classloader fails to load the third object class.

4. The method of claim 3 wherein the third object class of the second destructible classloader contains a variation of the classes specified in the second object class.

5. The method of claim 1 wherein the object-oriented application is an object-oriented development environment.

6. The method of claim 5 wherein the object-oriented development application is operating when the second object class is made accessible to the object-oriented development application by the destructible classloader.

7. The method of claim 1 wherein the object-oriented application operates substantially throughout a twenty-four hour period, wherein the object-oriented application is operating when the second object class is made accessible to the object-oriented development application by the destructible classloader.

8. The method of claim 1 wherein the object-oriented application includes web server means.

9. The method of claim 1 wherein the first classloader is a classloader that originated the classload request.

10. The method of claim 9 wherein the second classloader is a system classloader.

11. The method of claim 10 wherein the first and second classloaders operate within a Java-based environment.

12. The method of claim 1, wherein classload requests traverse a hierarchy of classloaders,
wherein before creating the destructible classloader, the classload requests travel from a user classloader to a system classloader to an extensions classloader to a bootstrap classloader; and
wherein after creating the destructible classloader, the classload requests travel from the user classloader to the destructible classloader to the system classloader to the extensions classloader to the bootstrap classloader.

13. The method of claim 1, wherein the first and second classloaders operate within a Java-based environment, wherein invocation of a predetermined method returns the second classloader, said method further comprising the step of:
manipulating the method such that the method returns the destructible classloader instead of the second classloader.

14. The method of claim 13 wherein the destructible classloader is a child of the second classloader.

15. The method of claim 14 wherein the second classloader is system classloader.

16. A computer-implemented system for loading object classes into computer memory for access by an object-oriented application, comprising:
a pre-existing class loading hierarchy that specifies parent-child relationships of classloaders;
a class loading operation that provides one of the classloaders in the pre-existing class loading hierarchy when the class loading operation is called, wherein the provided classloader is used to make accessible to the application an object class; and
a classloader switching module that inserts a first destructible classloader into the pre-existing class loading hierarchy by causing the class loading operation to provide the first destructible classloader when the class loading operation is called,
wherein after the first destructible classloader is inserted into the pre-existing class loading hierarchy, the first destructible classloader makes accessible for loading into the computer memory a first object class.

17. The system of claim 16 wherein the first destructible classloader contains the first object class.

18. The system of claim 16 wherein the classloader switching module inserts the first destructible classloader into the pre-existing class loading hierarchy upon receiving a first classloader switch command.

19. The system of claim 16 wherein the classloader switching module unloads the first destructible classloader and loads a second destructible classloader upon receiving a second classloader switch command, wherein the second destructible classloader makes accessible for loading into the computer memory a second object class.

20. The system of claim 19 wherein the second object class includes classes that were not in the first object class.

21. The system of claim 19 wherein the second object class includes classes that are a variation of at least one class in the first object class.

22. The system of claim 16 wherein the object-oriented application is an object-oriented development environment.

23. The system of claim 22 wherein the object-oriented development application is operating when the first object class is made accessible to the object-oriented development application by the first destructible classloader.

24. The system of claim 16 wherein the object-oriented application operates substantially throughout a twenty-four hour period, wherein the object-oriented application is operating when the first object class is made accessible to the object-oriented development application by the first destructible classloader.

25. The system of claim 16 wherein the object-oriented application includes web server means.

26. The system of claim 16 wherein the first destructible classloader operates within a Java environment, wherein the pre-existing class loading hierarchy includes a system classloader, wherein the classloader switching module manipulates the class loading operation such that the class loading operation returns the first destructible classloader instead of the system classloader.

27. The system of claim 26 wherein the first destructible classloader is a child of the system classloader.

28. The system of claim 27 wherein the class loading operation is an object-oriented based method call within the Java environment.
